(19) United States
(12) Patent Application Publication
(10) Pub. No.: US 2006/0131390 A1
(43) Pub. Date: Jun. 22, 2006

(54) Method and system for providing transaction notification and mobile reply authorization

(76) Inventor: Mike Insang Kim, Rancho Santa Margarita, CA (US)

Correspondence Address: Walter T. Kim, 2030 Main Street, Suite 1300, Irvine, CA, 92614, US

(21) Appl. No.: 11/015,597

(22) Filed: Dec. 16, 2004

(51) Int. Cl. G06K 5/00; G06Q 40/00

(52) U.S. Cl. 235/380; 705/44

(57) ABSTRACT

A system and a corresponding method are described for providing a notification of a pending transaction request and obtaining an authorization from a cardholder. The system maintains a database of account records, each of the account records including a phone number of a mobile device assigned to receive authorization request messages for the respective account. When a transaction request is received, the system determines a phone number of a mobile device assigned to receive authorization request messages for the account requesting the transaction by searching the database. The system generates and transmits an authorization request message to the phone number of the mobile device assigned to the account requesting the transaction. In response to the authorization request message, a reply message is returned from the mobile device, which explicitly indicates if a user of the mobile device approves or denies the transaction.

### BACKGROUND OF THE INVENTION

1. Field of the Invention

The present invention generally relates to processing commercial transactions, and in particular, to a system for detecting and preventing fraudulent use of credit and debit cards.

2. Description of the Related Art

The number of consumers using the Internet to make online purchases continues to increase. In such credit card transactions, because consumers are making the transactions by inputting information from a remote location, merchants cannot check for picture identification and/or compare the purchaser's signature with a signature on the card to verify that the purchaser is an authorized card user. Moreover, because it is not even necessary to have the physical credit card itself when transactions are made from remote locations, a credit card thief may be able to make an unauthorized charge simply by finding a sales slip with someone else's account number and expiration date. Fraudulent and unauthorized use of credit cards is a concern for all those involved in credit card transactions, including the card users, banks and financial institutions that provide credit cards. It has been estimated that credit card fraud losses may be in the range of billions of dollars a year, which is ultimately paid by the consumers through higher credit card charges and higher purchase prices.

Systems employing smart cards have been disclosed. Smart cards include a microprocessor with a memory element embedded within a physical card or device and may contain various information, such as the amount of funds in a particular account, a transaction history, account numbers and other customer data. Although various smart card systems have been proposed which attempt to provide security against fraudulent transactions, they do not address the problem of fraudulent use of conventional transaction cards (e.g., credit or debit cards having non-secure magnetic stripe data memories). Furthermore, there are a number of disadvantages associated with smart card systems. For one thing, smart cards require a smart card reader which is specifically configured to read the smart cards. Therefore, authentication or security features of smart card systems may not be performed when such smart card readers are unavailable.

### BRIEF SUMMARY OF EMBODIMENTS THE INVENTION

Described herein are various embodiments of a system and a correspond method for providing a notification of a pending transaction to an authorized cardholder and obtaining a reply from the cardholder indicating either approval or denial of the notified transaction. The system may be configured to transmit a transaction notification message to a mobile device associated with an account requesting a transaction. In response to receiving the transaction notification message, a user of the mobile device may generate and send a reply message to indicate approval or denial of the transaction.

According to an embodiment, the system includes the functionality to enable each of the authorized cardholders to designate a phone number of a mobile device for receiving authorization request messages and for transmitting mobile reply authorization messages. The phone number information is associated with a corresponding account number and stored in a cardholder information database. The information stored in the cardholder information database may be searchable by a phone number retrieving program executed within a server. In one embodiment, the phone number retrieving program is provided and the information arranged in the cardholder information database such that an account number search will located the relevant phone number information designated to handle authorization request messages for the account.

According to an embodiment, a transaction authorization server is used to perform a mobile reply authorization process (“MRAP”) to provide transaction notification and mobile reply authorization services. The MRAP requires that transaction requests submitted by merchants, payment servers and/or transaction computers be reviewed and authorized by the cardholder before a transaction authorization message is returned to the respective merchants, payment servers and/or transaction computers. The MRAP begins by examining a transaction request to identify the account number and determine a phone number of a mobile device assigned to receive authorization request messages. The server generates an authorization request message based on information contained in the transaction request and transmits the authorization request message to the mobile device assigned to the account requesting the transaction. A user of the mobile device receiving the authorization request message can utilize a software program executed in the mobile device to view the message and generate and send a reply message. Once the reply message is received from the mobile device, the server examines the reply message to determine if the user of the mobile device approves or denies the transaction request.

According to an embodiment, the transaction authorization server also includes the functionality to validate reply messages received from mobile devices. In one embodiment, the server includes a pending transaction database which contains information pertaining to pending transaction requests. Identifying information uniquely identifying each of the pending transaction requests is stored in the pending transaction database. Upon being presented with a reply message, the server may retrieve from the database a pending transaction record corresponding to the reply message by matching the unique identifying information specified in the reply message with corresponding information stored in the database. Then, the server may verify that the reply message is sent from a proper mobile device by matching the phone number transmitting the reply message with the phone number included in the retrieved record.

According to an embodiment, the transaction authorization server further includes the functionality to enable a card provider and/or a card holder to select one or more conditions for triggering execution of the MRAP for a particular transaction. The selected trigger conditions are associated with a corresponding account number and stored in a cardholder information database. When a transaction request is received for a particular account, trigger condition information pertaining to the requesting account is retrieved from the cardholder information database. Then, the server determines if one of the trigger conditions for requiring execution of the MRAP is satisfied based on the information contained in the transaction request.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIG. 1 shows a block diagram of a system for performing secure online transactions according to an embodiment of the present invention.

FIG. 2 shows a block diagram of a transaction authorization server coupled to a cardholder information database according to an embodiment of the present invention.

FIG. 3 shows a flowchart diagram of a process for processing an online transaction request according to an embodiment of the present invention.

FIG. 4 shows a flowchart diagram of a process for validating and analyzing reply messages received from mobile devices according to an embodiment of the present invention.

FIG. 5 shows a flowchart diagram of a process for enabling selection of conditions for triggering an execution of a mobile reply authorization process according to an embodiment of the present invention.

### DETAILED DESCRIPTION OF THE INVENTION

In the following description, specific details are set forth in order to provide a thorough understanding of various embodiments of the present invention. However, it will be apparent to one skilled in the art that embodiments of the present invention may be practiced without these specific details. In other instances, well-known hardware and software components, structures and techniques have not been shown in detail in order to avoid obscuring embodiments of the present invention.

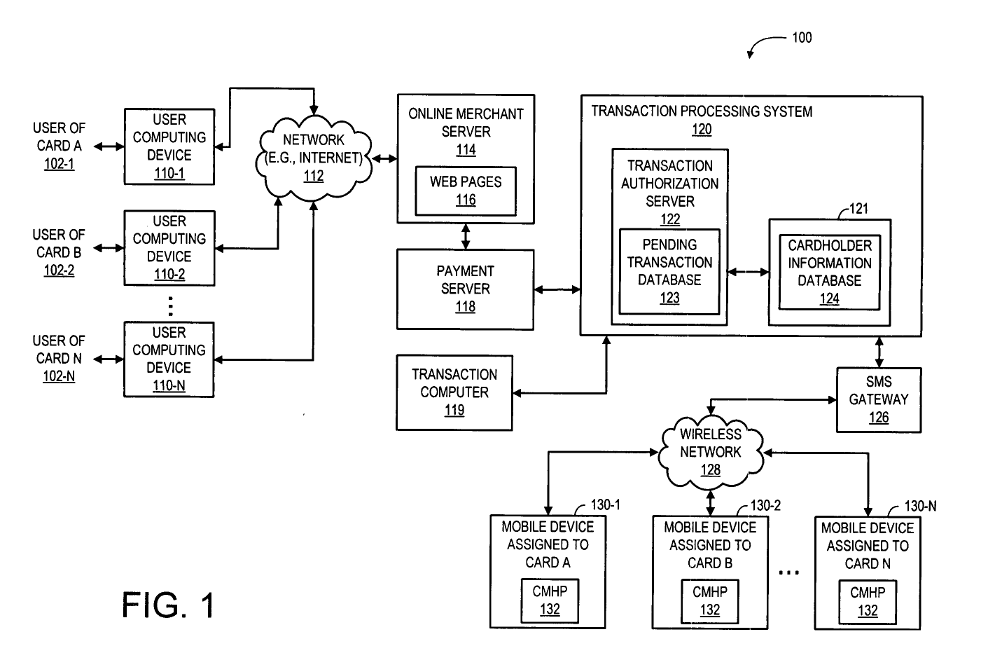

Shown in FIG. 1 is a simplified representation of a system 100 to facilitate secure sales transactions in accordance with an embodiment of the present invention. In this system, credit card users 102-1 through 102-N can connect with an online merchant server 114 via a network 112 using their user computing devices 110-1 through 110-N. The network 112 may include, for example, the Internet, a virtual private network (“VPN”), a wide area network (“WAN”) and/or a wireless network to enable data transmission between the user devices 110 and merchant server 114. The user computing devices 110 can be any suitable device capable of establishing communication with the network, including personal computers, laptop computers, and/or wireless communications devices (e.g., cellular phones, personal digital assistants (“PDAs”)).

The merchant server 114 may be operated by a merchant offering various goods and/or services and may be an application server, a web server or any other type of server capable of offering electronic commerce services over the Internet. A card user 102 may use Web browser software running on the user's computing device to access and interact with Web pages 116 and other information provided by the merchant server 1114 in which various types of goods and/or services are described and/or shown. To make a purchase, a card user 102 may provide the merchant 114 with transaction information required for conducting a transaction, such as, for example, the account number and expiration date of a transaction card. In one embodiment, the transaction card used is a credit or debit card having a non-secure magnetic stripe data memory.

The merchant server 114 may forward the transaction information provided by the card user and information about the purchase, such as price, item description and date of transaction to a payment server 118. The payment server 118 may then generate a transaction request based on the transaction information received from the merchant server and forward the transaction request to a transaction processing system 120 that handles transactions for the specific transaction card. The system 120 processes the transaction request and returns an authorization granted or denied message to the payment server 119. The payment server 119 forwards the message from the system 120 to the merchant server 114 and based on the message, the merchant server 114 may complete the purchase requested by the card user.

In an embodiment, the transaction processing system 120 is also configured to receive transaction requests from a transaction computer 119. The transaction computer 119 may be any special purpose device capable of handling transactions, including but not limited to automatic teller machines (“ATMs”), point of sale (POS) terminals and credit card terminals.

Although only one merchant server 114, only one payment server 118 and only one transaction computer 119 are illustrated in FIG. 1, it should be understood that any number of merchant servers, payment servers and transaction computers 119 may be coupled to the transaction processing system 120 to submit transaction requests and receive transaction approval or denial information. The communication between the payment server 118 and the system 120 may be established using any suitable communication means, such as the Internet, the public switched telephone network, dedicated communication lines, or a combination thereof. Similarly, the communication between the transaction computer 119 and the system 120 may be established using any suitable communication means, such as the Internet, the public switched telephone network, dedicated communication lines, or a combination thereof.

The transaction processing system 120 may be maintained and operated by a card provider, a bank, a financial institution or other types of institutions. The system 120 may include one or more servers coupled to one or more databases. In the illustrated embodiment, the system 120 includes a transaction authorization server 122 which is in communication to receive transaction requests. The server 122 enables a card provider to notify its cardholder of pending transaction requests so that unknown or fraudulent charges can be immediately identified. Additionally, the server 122 enables the card provider to obtain direct authorization from cardholders to ensure that the transaction requests are being made by the authorized cardholders.

A storage device 121 is in communication with the server 122 for storing cardholder information database 124. The cardholder information database 124 may include account information of each cardholder such as the cardholder identification, account number, billing address, phone numbers and other information such as the credit limit and account balance associated with each account. When an applicant applies to open an account (e.g., credit card account) with a card provider, the card provider may request that the applicant provide a phone number of a mobile device to which the applicant desires to receive authorization request messages. The phone number information is associated with the account number and stored in the cardholder information database 124.

The transaction processing system 120 is coupled to a wireless network 128 via a data transport interface, such as Short Message Service (“SMS”) gateway 126. In one embodiment, text messages between the system 120 and mobile devices 130-1 through 130-N are transmitted and received using SMS text messaging. In this regard, SMS gateway 126 facilitates communication between the system 120 and the wireless network using SMS protocol. Although SMS text messaging protocol is used in one embodiment to send authorization request messages to and receive reply messages from mobile devices, other types of communication protocol may be employed to transmit and receive the messages, including protocols that can convey sound, data, images or any combination of thereof. Wireless network 128 may be a Global System for Mobile communications (“GSM”) network or any other appropriate network that facilitates wireless communication to and from mobile devices 130-1 through 130-N.

Each mobile device 130 is preferably a wireless communication device capable of sending and receiving messages over a wireless network and displaying the messages to a user. Mobile device can be cellular phones, personal digital assistants (PDAs) and/or other types of mobile devices. The mobile device 130 may include a client message handling program (“CMHP”) 132 that enables the user to access the authorization request message sent by the server 122 and to respond to the authorization request message by generating a reply message (e.g., approval or denial of the transaction). In one embodiment, the CMHP 132 executed by the mobile device is a text messaging program which enables the user to generate a reply message by attaching a response (indication of approval or denial) to at least a portion of the authorization request message.

In another embodiment, the CMHP 132 executed by the mobile device 130 is a message handling application which is specifically configured to handle authorization request messages from the server 122 and to generate and transmit reply message to the server 122. In one implementation, the CMHP 132 recognizes the format of authorization request messages sent from the server 122. Similarly, the message analyzing program 40 provided on the server 122 recognizes the format of reply messages generated by the CMHP 132. The CMHP 132 executed by the mobile device 130 includes the functionality to display transaction information included in an authorization request message to the user, which may include (i) the merchant name, (ii) the date of the transaction, (iii) the merchant location, and (iv) the purchase amount. Another function provided by the CMHP 132 is to prompt the user to input a response (e.g., approval or denial of the transaction) by pressing designated buttons on the mobile device. In one implementation, one of the buttons on the mobile device is designated for accepting the charge and another one of the buttons is designated for declining the charge. Accordingly, the user may respond to the authorization request message by simply pressing a button that corresponds with a desired response. Based on the user's input, the CMHP 132 generates a reply message which includes information regarding whether or not the user of the mobile device approves the transaction and sends the reply message to the system 120.

In accordance with one embodiment, the transaction processing system 120 facilitates detection and prevention of fraudulent credit card charges without employing “smart card” type device embedded within a transaction card or incorporated within a message handling mobile device. Accordingly, in one embodiment, the system 100 does not require that the message handling mobile devices contain or have access to information regarding credit card account numbers or other credit card related information regarding cardholders.

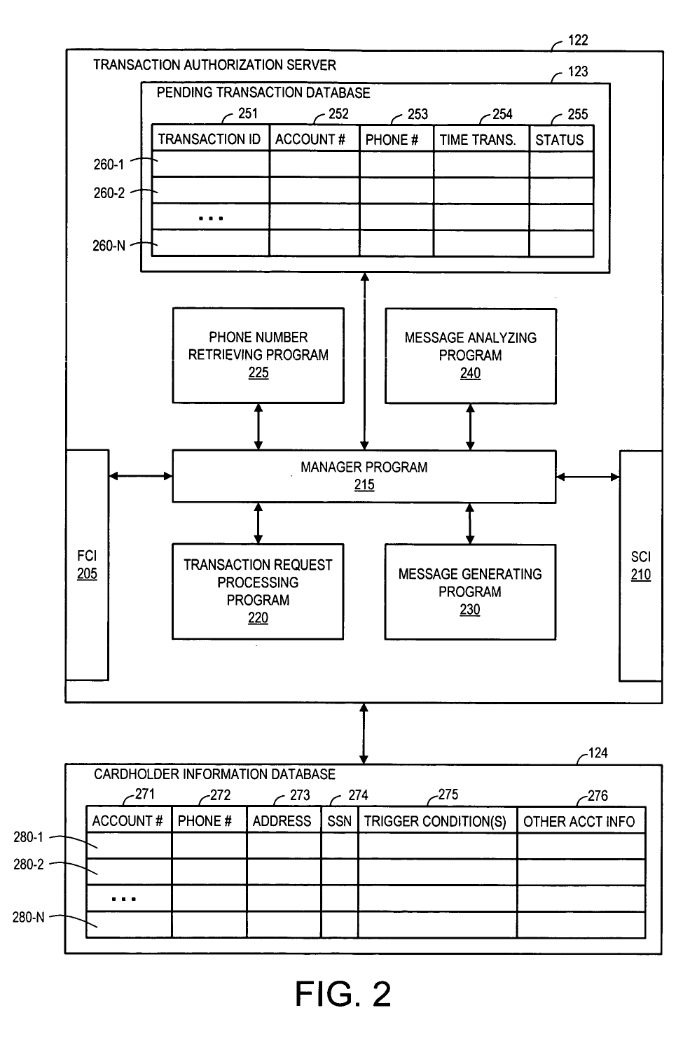

FIG. 2 shows simplified representation of a transaction authorization server coupled to a cardholder information database according to an embodiment of the present invention. The transaction authorization server 122 includes a first communication interface (“FCI”) 205 to establish communication with payment servers 118 and/or transaction computers 119 and a second communication interface (“SCI”) 210 to establish communication with mobile devices 130. The server 122 further includes a manager program 215, a transaction request processing program 220, a phone number retrieving program 225, a message generating program 230, a message analyzing program 240 and a pending transaction database 123 accessible by programs 215, 220, 225, 230 and 240. Although the software programs 215, 220, 225, 230 and 240 are shown as separate software programs, it should be noted that any suitable arrangement of software components can be employed to provide the functionalities described herein. For example, software programs 215, 220, 225, 230 and 240 can be integrated into one or more software applications executed by the server 122. Further, in various embodiments, hard-wired circuitry may be used in place of or in combination with software instructions to implement the functionalities described herein. Thus, the embodiments of the present invention are not limited to any specific combination or arrangements of hardware circuitry and software components.

The pending transaction database 123 is used to maintain records of pending transaction requests, which are waiting for a reply from cardholders. In one embodiment, the pending transaction request records are generated from transaction requests and each record includes a transaction identification code or number (“transaction ID”) uniquely identifying the transaction. More specifically, in the illustrated embodiment, each record 260-1 through 260-N of the database 123 includes (i) a Transaction ID column 251 to store a transaction ID that has been assigned to a corresponding transaction request, (ii) an Account # column 252 to store an account number requesting the transaction request, (iii) a Phone # column 253 to store a phone number of a mobile device associated with the account number, (iv) a Time of message Transmission column to record the time when the authorization request message was transmitted, and (v) a Status column to contain information relating to the status of the transaction request, such as waiting for reply, approval reply received, denial reply received, invalid reply received, etc. Other information pertaining to a transaction may also be included in the database 123, such as date and time of the requested transaction, merchant name, merchant location, description of the purchase item, purchase amount and/or other relevant information.

As shown in FIG. 2, the transaction authorization server 122 is in communication with the cardholder information database 124 to access account information required to process transaction requests. The cardholder information database 124 includes a number of records 280-1 through 280-N, each record containing information relating to an account issued by a card provider. In one embodiment, each record 280 of the cardholder information database 124 contains (i) an Account # column 271 to store an account number for a transaction card, (ii) a Phone # column 272 to store a phone number of a mobile device assigned to receive authorization request messages, (iii) an Address column 273 to store a billing address associated with the account number, (iv) a SSN column 274 to store a social security number of the account holder, (v) a Trigger Condition(s) column 275 to store information relating to condition(s) for triggering a mobile reply authorization requirement, and (vi) an Other Acct Info column 276 to store other information relating to the account. Although FIG. 2 shows that the phone number information 272 is stored in the cardholder information database 124 along with other account information, it will be appreciated that the phone number information may be stored in another database separate from the cardholder information database.

The manager program 215 provided on the transaction authorization server 122 is configured to manage processing of transaction requests and to manage messages sent and received from mobile devices. The phone number retrieving program 225 is configured to identify a phone number of a mobile device assigned to receive an authorization request message based on the account number information included in a transaction request by searching through the cardholder information database 124. The transaction request processing program 220 is configured to perform various functions necessary for processing a transaction request, such as determining the accuracy of the information contained in the transaction request, determining the status of the account (e.g., valid account or invalid account), and/or determining if the purchase amount is within the credit limits. The message generating program 230 is configured to generate an authorization request message which provides notification of a pending transaction request and requests a reply indicating either an approval or denial of the transaction. The message analyzing program 240 provided on the server 122 is configured to examine the reply message to determine its validity and to determine whether or not the transaction is approved by a user of the mobile device based on the content of the reply message.

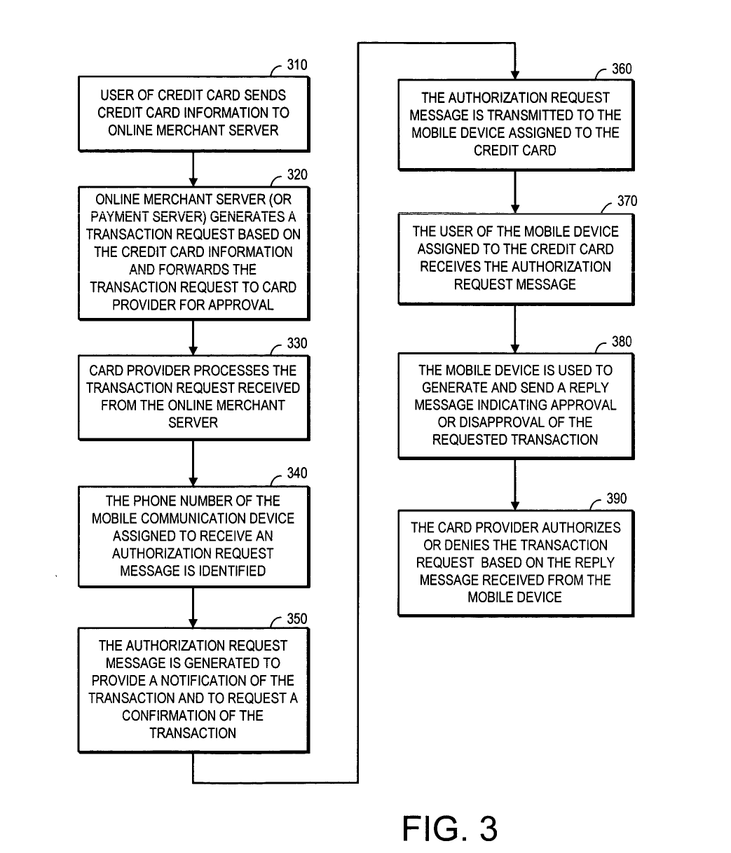

FIG. 3 shows general operations involved in processing an online card transaction according to an embodiment of the present invention. A user 102 of a credit card connects to an online merchant server 114 via a computing device 110, which prompts the user to input information required to carry out an electronic credit card transaction, such as the account number and expiration date of the credit card and optionally other personal information (e.g., the name, social security number, date of birth and billing address of the authorized cardholder). Thus in block 310, the user 102 inputs the requested data into the user's computing device and sends the credit card information to the online merchant server 114 via a network connection (e.g., Internet).

It should be noted that because of transaction notification and authorization features provided by various embodiment of the present invention, some of the personal or sensitive information currently required to carry out a conventional online credit card transaction may be omitted, such as the name of the credit card holder, the billing address, the social security number and date of birth of the cardholder and the like. In one embodiment, only information required by the merchant server to carry out an online credit card transaction using the system of the present invention is the account number of a transaction card. In another embodiment, the server 122 will process a transaction request without requiring submission of one or more of the following information: (i) the cardholder's social security number, (ii) the cardholder's date of birth, (iii) the cardholder's phone number, and (iv) the cardholder's billing address.

The information send by the card user 102 is collected by the online merchant server 114 and based on this information the online merchant server 114 or the payment server 118 generates a transaction request and forwards the transaction request to the system 120 for approval in block 320. Then in block 330, the transaction request processing program 220 on the server 122 is used to perform an initial processing of the transaction request received from the online merchant server 114. The transaction processing system 120 has an access to a cardholder information database that contains account information relating to each of its issued credit cards, such as the credit card numbers, expiration dates, billing addresses and credit limits of its cardholders. The information contained in the transaction request is compared with information included in the database to ensure that the requesting credit card is a valid account issued by the card provider and that the amount of the transaction is within the card user's credit limit.

If the requesting account is a valid account issued by the card provider, the server 122 may perform a mobile reply authorization process (“MRAP”) to send a notification of the transaction and request authorization from the cardholder. The MRAP will be described more in detail with respect to blocks 340 through 390. In one embodiment, the MRAP is used to provide a notification of a pending transaction in the form of a text message to a mobile device of a cardholder and to obtain a reply message in a text message from the same mobile device indicating either approval or denial of the transaction. The MRAP begins in functional block 340 with the phone number retrieving program 225 on the server 122 retrieving a phone number of a mobile device assigned to the requesting account by searching the cardholder information database 124. In one embodiment, the phone number retrieving program 225 functions as a search engine and the information is arranged in the cardholder information database 124 such that an account number search will locate the relevant phone number designated to handle authorization request messages for the account.

To provide a notification of the pending transaction and to request a confirmation of the transaction directly from a user of the assigned mobile device, the message generating program 230 on the server 122 is used to generate an authorization request message based on the information contained in the transaction request in block 350. The authorization request message may be in a form of a text message containing one or more of the following information: (i) the transaction ID, (ii) the date of the transaction, (iii) the purchase description, (iv) the purchase amount, (v) the name of the merchant, and (vi) the location of the merchant. Then in block 360, the server 122 transmits the authorization request message to the phone number of the mobile device assigned to the requesting account via a wireless network 128.

Once the authorization request message has be received by the mobile device in block 370, the user of the mobile device 130 can use the text messaging program 132 to access the authorization request message to verify the transaction information. The text messaging program 132 executed on the mobile device 130 may prompt the user to input a response (e.g., approval or denial of the transaction) by pressing designated buttons on the mobile device. Based on the user's input, the text messaging program 132 generates a reply message which includes information regarding whether or not the user of the mobile device approves the transaction. In addition, the reply message may also contain (i) the transaction ID included in the original authorization request message, and (ii) other information pertaining to the transaction, such as the description of the purchase, purchase amount, date of the purchase and name of the merchant.

In block 380, the reply message generated by the mobile device is transmitted to the server 122. When the reply message is received by the server 122, the message analyzing program 240 on the server 122 is used to determine its validity and to determine if the requested transaction is approved or denied by the mobile device user. In block 390, if the reply message approves the transaction, the system 120 will send an authorization granted message to the online merchant server 114 via the payment server 118 indicating that the merchant is authorized to accept this credit card transaction. Otherwise if the reply message denies the transaction, the system 120 is configured to send an authorization denied message instructing that the payment server 118 and the merchant 114 to deny this credit card transaction. In addition, whenever a reply message denying a transaction is received by the server 122, the card provider may immediately suspend the corresponding credit card account to prevent any further fraudulent use.

By utilizing a reply message received from a mobile device assigned by an authorized cardholder, the number of fraudulent use of the credit card can be significantly reduced since fabricating such reply message by a fraudulent user from the same mobile device phone number may be difficult, if not impossible, without actually possessing the mobile device itself. Typically, fraudulent use of a credit card occurs when the credit card is lost, stolen or the account number is compromised. The transaction processing system 120 according to embodiments of the present invention requires that a person attempting to make an unauthorized charge to possess both the credit card and the mobile device of the authorized cardholder. Since most people know immediately when they have lost their mobile devices, the mobile device designated for transmitting an authorization reply message will not be readily available to a thief who has possession of either the physical credit card or the account number of a credit card. Furthermore, because the reply message serves to authenticate the card user, it may not be necessary to verify the identity of the card user during each sales transaction, for example, by checking picture identification and/or comparing the purchaser's signature. This may advantageously save time for the card user and the merchant.

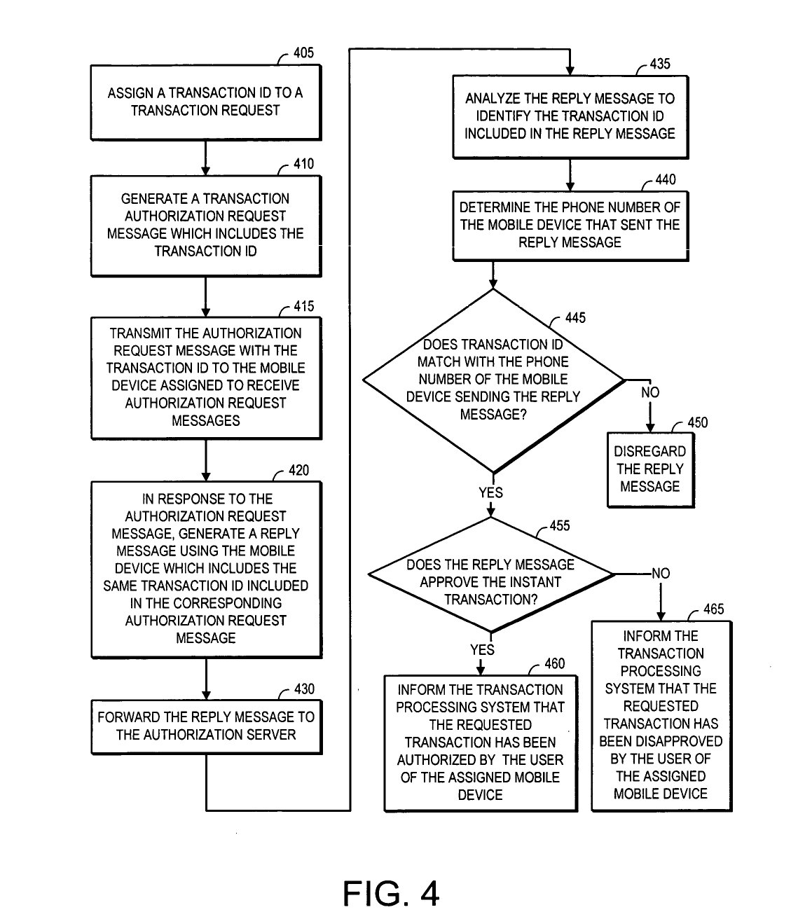

FIG. 4 shows general operations involved in validating and analyzing reply messages received from mobile devices according to an embodiment of the present invention. During the processing of each individual transaction request, a transaction ID may be assigned to each respective transaction request by the transaction processing system 120 for the purpose of identifying each individual transaction request. In one embodiment, the transaction ID assigned to each respective transaction request is used to identify authorization request messages sent to mobile devices and the same transaction ID is used to identify reply messages returned from the mobile devices.

In block 405, a transaction ID is assigned to a transaction request before an authorization request message is generated. In block 410, the message generating program 230 on the server 122 is used to generate an authorization request message which includes the transaction ID. Once the authorization request message has been generated, the server 122 sends the message with the transaction ID to the mobile device associated with the requesting account in block 415. In response to the authorization request message, the user of the mobile device may use a software program on the mobile device to generate a reply message, which automatically includes in the reply message the same transaction ID included in the corresponding authorization request message in block 420.

The reply message is sent to the transaction authorization server 122 and the server 122 uses the message analyzing program 240 to determine the transaction ID included in the reply message in block 435. At the same time, the server 122 determines the phone number of the mobile device that sent the reply message in block 440. Based on the information determined in 435 and 440, the message analyzing program 240 determines if the reply message has been returned by the intended mobile device. More specifically, the message analyzing program 240 determines if the transaction ID specified in the reply message properly corresponds with the phone number of the mobile device sending the reply message in block 445.

This may be accomplished, in one embodiment, by accessing the pending transaction database 123 which includes records of pending transaction requests. Each pending transaction record includes, among other things, the transaction ID assigned to each transaction request and the phone number of the mobile device designated to receive the authorization reply message. Accordingly, the message analyzing program can determine if the proper mobile device sent the reply message by comparing the phone number of the mobile device sending the reply message with the phone number associated with the record (retrieved from the pending transaction database 123) having the same transaction ID as specified in the reply message in the pending transaction database 123.

If the phone number of the mobile device sending the reply message does not match with the transaction ID (block 445, no), this means that the reply message was sent from an improper mobile phone and the reply message will be disregarded in block 450. On the other hand, if the phone number of the mobile device sending the reply message does match with the transaction ID (block 454, yes), this means that the reply message was received from the proper mobile device and the reply message is further analyzed to determine whether or not the user of the mobile device has approved the transaction request in block 455. Based on the content of the reply message, if the message analyzing program 240 determines that the user has approved the transaction (block 455, yes), the transaction authorization server inform the transaction processing system 120 that a proper authorization has been received from the authorized cardholder in block 460. Otherwise, if the message analyzing program 240 determines that the user has denied the transaction (block 455, no), the authorization server 122 will send a message to the transaction processing system 120 indicating that the authorized cardholder has denied the transaction request in block 465.

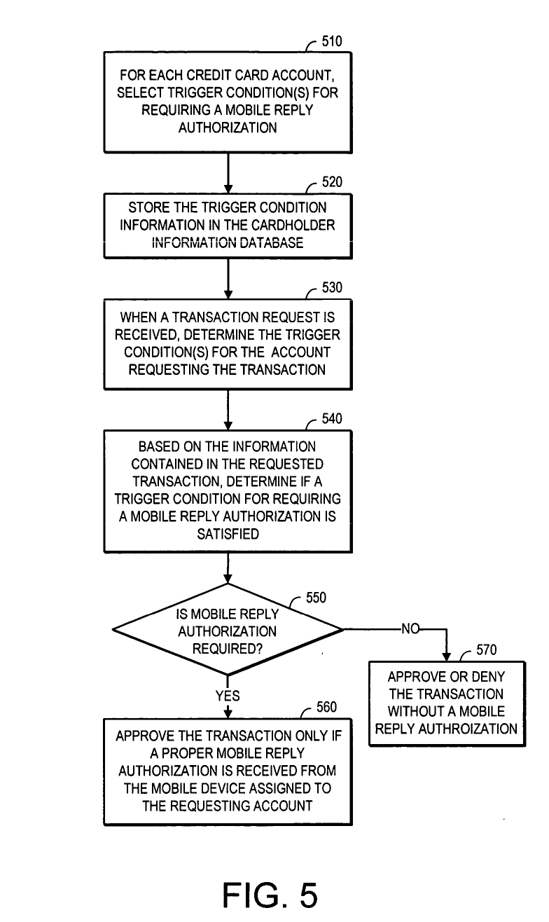

In an embodiment, the server 122 provides a card provider and/or a card holder with the ability to select one or more conditions for triggering an execution of the mobile reply authorization process (“MRAP”) during processing of a particular transaction. FIG. 5 shows general operations of enabling selection of trigger conditions according to an embodiment of the present invention. In one embodiment, the transaction authorization server 122 may choose not to perform the MRAP for certain transaction requests that satisfy the selected trigger conditions. For example, in a case where a cardholder desires to avoid using the MRAP in transactions involving less than certain purchase amount (e.g., $50), the server 122 can be configured to require performance of the MRAP only when transaction requests involves an amount greater than $50. In such case, any transactions involving an amount less than the threshold amount (e.g., $50) will not require performance of the MRAP.

In block 510, a card provider and/or a cardholder may select one or more trigger conditions for requiring the MRAP. The card provider may choose one or more trigger conditions based on attributes of the account, such as, a credit limit on the account and/or the transaction history of the account. Other trigger conditions may be based on one or more of the following transaction attributes: (i) the type of purchase item (e.g., not requiring MRAP for routine transactions such as gasoline purchases), (ii) the merchant location (e.g., requiring MRAP for transactions involving merchants located in a different state as the cardholder), and/or (iii) the type of transaction (e.g., requiring MRAP for online credit card transactions).

In block 520, the trigger condition information 275 is associated with a corresponding account number and stored in the cardholder information database 124. When a transaction request is received, the transaction processing system 120 retrieves trigger condition information 275 for the requesting account from the cardholder information database 124 in block 530. Then in block 540, the transaction processing system 120 determines if one of the trigger conditions for requiring a mobile reply authorization is satisfied based on the information contained in the transaction request. This may be accomplished by comparing the trigger conditions with appropriates field contained in the transaction request. If the transaction processing system 120 determines that a mobile reply authorization is required (block 550, yes), the transaction authorization server 122 will generate an authorization request message and forward the message to the mobile device assigned to the account requesting the transaction. In this regard, in block 560, the transaction processing system 120 will approve the transaction only if a proper mobile reply authorizing the transaction (e.g., via a reply message) is received from the mobile device assigned to the requesting account. If the card provider determines that a mobile reply authorization is not required (block 550, no), the transaction processing system 120 may approve the transaction without an authorization reply from the cardholder's mobile device if other conditions (e.g., the purchase amount is within the credit limit) for approving the transaction request is satisfied in block 570.

Although the system described above allows card users to engage in online transactions with merchant servers, it should be appreciated that the system described herein may be used by card users conducting offline transactions by communicating directly with sales agents working for merchants either face-to-face or using communication devices (e.g., wired or wireless communication device) to exchange the necessary information to carry out sales transactions. In such cases, the sales agents may manually enter the information provided by the card users into the merchant system, which will generate and sent the transaction requests to the transaction processing system of the card provider. Thus, the embodiments of the present invention are not limited to online transactions, but rather, the embodiments can be used with offline merchants accepting transaction card payments. Furthermore, as shown in FIG. 1, the transaction processing system 120 can be used to process transaction requests from the transaction computer 119, such as automatic teller machines (ATMs), point of sale (POS) terminals, credit card terminals and the like.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. A method comprising:
maintaining a database that includes a plurality of account records, at least one of the account records including: (i) an account number and (ii) a phone number of a mobile device assigned to receive authorization request messages;
receiving a transaction request which includes information regarding an account requesting a transaction; and
determining a phone number of a mobile device assigned to receive authorization request messages for the account requesting the transaction by searching the database;
generating an authorization request message based on information contained in the transaction request;
transmitting the authorization request message to the phone number of the mobile device assigned to the account requesting the transaction; and
receiving a reply message from the mobile device assigned to the account requesting the transaction.

2. The method of claim 1, further comprising:
examining the reply message to determine if the user of the mobile device denies the transaction request.

3. The method of claim 1, further comprising:
examining the reply message to determine if the user of the mobile device approves the transaction request.

4. The method of claim 1, further comprising:
validating the reply message by comparing the phone number of the mobile device sending the reply message with the phone number of the mobile device to which the corresponding authorization request message was sent.

5. The method of claim 1, further comprising:
including an identification information in the authorization request message;
including the same identification information in the corresponding reply message;
determining if the reply message has been sent by a proper mobile device based on the identification information included in the reply message and the phone number of the mobile device sending the reply message.

6. The method of claim 1, wherein the transaction request is received from one of following sources: (i) an online merchant server, (ii) a payment server, (iii) an automatic teller machine (ATM), (iv) a point of sale (POS) terminal and (v) a credit card terminal.

7. A method comprising:
receiving a transaction request;
transmitting a first message to a mobile device associated with an account requesting the transaction request; and
receiving a second message from the mobile device associated with the account requesting the transaction request, wherein the second message include an indication that a user of the mobile device denies the transaction request.

8. The method of claim 7, further comprising:
denying the transaction request based on information included in the second message.

9. The method of claim 7, wherein the first message is a text message containing following information: (i) a transaction identification, (ii) a purchase description, (iii) a purchase amount, and (iv) a date of the transaction.

10. The method of claim 9, wherein the first message requests an authorization of the transaction request from the user of the mobile device.

11. The method of claim 9, wherein the second message is a text message containing following information: (i) the transaction identification and (ii) an indication of approval or denial of the transaction.

12. The method of claim 7, further comprising:
determining a phone number of the mobile device sending the second message; and
determining if the second message has been sent by a proper mobile device based on identification information included in the second message and the phone number of the mobile device sending the second message.

13. The method of claim 7, further comprising:
determining if a mobile reply authorization is required to process the transaction request based on at least one condition associated with the account requesting the transaction.

14. The method of claim 7, wherein the transaction request is received from one of following sources: (i) an online merchant server, (ii) a payment server, (iii) an automatic teller machine (ATM), (iv) a point of sale (POS) terminal and (v) a credit card terminal.

15. A system comprising:
a transaction processing system coupled to receive transaction requests, each transaction request including information regarding an account requesting a transaction;
a plurality of mobile devices capable of establishing communication with the transaction processing system via a wireless network, each of the mobile devices having a phone number; and
a first database coupled to the transaction processing system to store a plurality of account records, at least one of the account records including: (i) an account number and (ii) a phone number of a mobile device assigned to receive authorization request messages,
wherein the transaction processing system to determine a phone number of a mobile device assigned to receive authorization request messages for an account requesting a transaction by searching the first database, the transaction processing system to transmit an authorization request message to the phone number of the mobile device assigned to the account requesting the transaction, the transaction processing system to receive a reply message from the mobile device assigned to the account requesting the transaction, wherein the reply message includes an indication of approval or denial of the transaction.

16. The system of claim 15, further comprising:
a merchant server;
a client computer coupled to the merchant server via a public network, the client computer enabling a card user to provide the merchant server with transaction information for conducting an online transaction; and
a payment server coupled between the merchant server and the transaction processing system, the payment server to receive transaction information from the merchant server and to generate a transaction request based on information received from the merchant server, the payment server to forward the transaction request to the transaction processing system.

17. The system of claim 16, wherein the transaction information provided by the card user includes account number of a credit card.

18. The system of claim 15, further comprising:
a second database to store a plurality of pending transaction records, each pending transaction record including: (i) a transaction identification assigned to each individual transaction request, (ii) an account number requesting the transaction, and (iii) a phone number of mobile device to which an authorization request message has been transmitted.

19. The system of claim 15, wherein the first message functions as a notification of the transaction request to the user of the mobile device and the second message functions as an express authorization from the user of the mobile device.

20. The system of claim 15, further comprising:
a data transport interface coupled to the transaction processing system to transmit and receive text messages to and from mobile devices via a wireless network.

21. The system of claim 15, wherein the transaction processing system is capable of validating the second message by verifying that the second message was sent from a proper phone number.

22. The system of claim 15, wherein the transaction processing system is capable of determining trigger information for an account and determining if a particular transaction request pertaining to the account requires a mobile reply authorization based on the trigger information.

23. A transaction server comprising:
a first communication interface to receive information regarding transaction requests;
a second communication interface to establish communication with a plurality of mobile device via a wireless network; and
a processor coupled to the first communication interface and the second communication interface to generate an authorization request message based on a respective transaction request, wherein the authorization request message is forwarded via the second communication interface to a mobile device associated with an account requesting the respective transaction request.

24. The transaction server of claim 23, wherein the authorization request message serves to notify a user of the respective mobile device of a pending transaction request.

25. The transaction server of claim 23, wherein a reply message is received from the mobile device associated with the account requesting the transaction, wherein the reply message indicates if the transaction is approved by a user of the respective mobile device.

26. The transaction server of claim 25, further comprising:
a data storage to store information regarding pending transaction requests, the information regarding each pending transaction request includes an account number associated with the respective transaction request and a phone number of a mobile device associated with the account number.

27. The transaction server of claim 26, wherein the processor to determine if the reply message has been sent by a proper mobile device based on identification information included in the reply message and a phone number of the mobile device sending the reply message.

28. The transaction server of claim 23, wherein the processor to determine if a mobile reply authorization is required to process a respective transaction request based on at least one condition previously selected for an account requesting the respective transaction request.
